(19) United States
(12) Patent Application Publication
(10) Pub. No.: US 2015/0278589 A1
(43) Pub. Date: Oct. 1, 2015

(54) Image Processor with Static Hand Pose Recognition Utilizing Contour Triangulation and Flattening

(71) Applicant: Avago Technologies General IP (Singapore) Pte. Ltd., Singapore (SG)

(72) Inventors: Ivan Leonidovich Mazurenko, Khimki (RU); Alexander Borisovich Kholodenko, Moscow (RU); Dmitry Nicolaevich Babin, Moscow (RU); Aleksey Alexandrovich Letunovskiy, Moscow (RU); Alexander Alexandrovich Petyushko, Bryansk (RU)

(21) Appl. No.: 14/668,625

(22) Filed: Mar. 25, 2015

(30) Foreign Application Priority Data
Mar. 27, 2014 (RU) 2014111793

(51) Int. Cl. G06K 9/00; G06K 9/46; G01C 11/30

(52) U.S. Cl. CPC G06K 9/00355; G01C 11/30; G06K 9/4604

(57) ABSTRACT

An image processing system comprises an image processor having image processing circuitry and an associated memory. The image processor is configured to implement a gesture recognition system utilizing the image processing circuitry and the memory. The gesture recognition system implemented by the image processor comprises a static pose recognition module. The static pose recognition module is configured to identify a hand region of interest in at least one image, to determine a contour of the hand region of interest, to triangulate the determined contour, to flatten the triangulated contour, to compute one or more features of the flattened contour, and to recognize a static pose of the hand region of interest based at least in part on the one or more computed features.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system utilizing the image processing circuitry and the memory. The gesture recognition system implemented by the image processor comprises a static pose recognition module. The static pose recognition module is configured to identify a hand region of interest in at least one image, to determine a contour of the hand region of interest, to triangulate the determined contour, to flatten the triangulated contour, to compute one or more features of the flattened contour, and to recognize a static pose of the hand region of interest based at least in part on the one or more computed features.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a static pose recognition module in an illustrative embodiment.

FIG. 2 is a flow diagram of an exemplary static pose recognition process performed by the static pose recognition module in the image processor of FIG. 1.

FIG. 3 shows an example of a hand image illustrating contour points and a palm boundary.

FIG. 4 illustrates portions of the FIG. 2 process as applied to an exemplary hand image.

FIG. 5 illustrates the addition of contour points to a hand image in a contour regularizing portion of the FIG. 2 process.

FIG. 6 illustrates an exemplary mapping of a 2D contour triangulation to a 3D contour triangulation in a contour triangulation portion of the FIG. 2 process.

FIGS. 7 and 8 illustrate a contour flattening portion of the FIG. 2 process.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing static poses in one or more images.

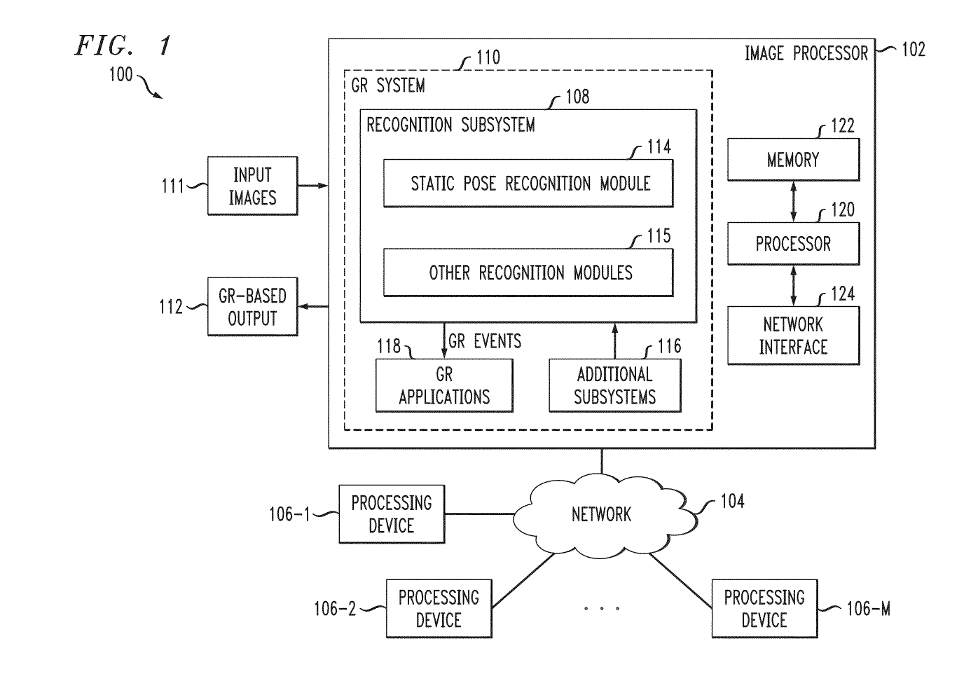

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 108 within a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

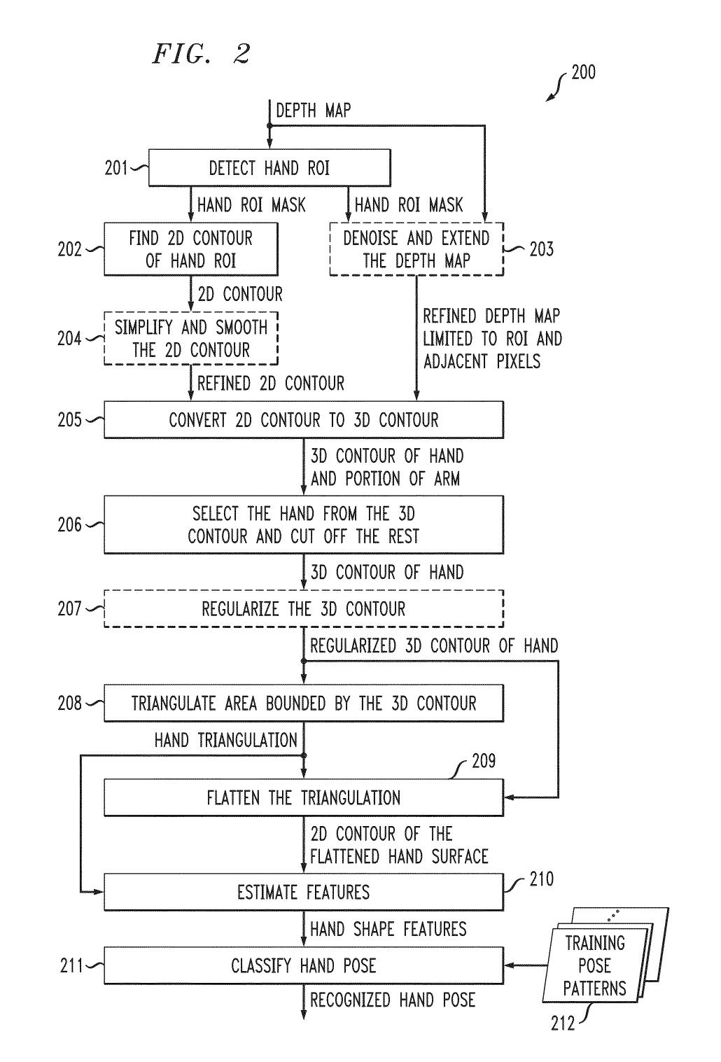

The recognition subsystem 108 of GR system 110 more particularly comprises a static pose recognition module 114 and one or more other recognition modules 115. The other recognition modules may comprise, for example, respective recognition modules configured to recognize cursor gestures and dynamic gestures. The operation of illustrative embodiments of the GR system 110 of image processor 102 will be described in greater detail below in conjunction with FIGS. 2 through 8.

The recognition subsystem 108 receives inputs from additional subsystems 116, which may comprise one or more image processing subsystems configured to implement functional blocks associated with gesture recognition in the GR system 110, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 110 are described in PCT International Application PCT/US13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 110 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 108 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 108 recognizes within the image a gesture from a specified gesture vocabulary and generates a corresponding gesture pattern identifier (ID) and possibly additional related parameters for delivery to one or more of the applications 118. The configuration of such information is adapted in accordance with the specific needs of the application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of the set of GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 110.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 108 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 110 from the depth sensor may include a stream of frames comprising respective depth images, with each such depth image comprising a plurality of depth image pixels. For example, a given depth image may be provided to the GR system 110 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 115, 116 and 118 of image processor 102. One possible example of image processing circuitry that may be used in one or more embodiments of the invention is an otherwise conventional graphics processor suitably reconfigured to perform functionality associated with one or more of the components 114, 115, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination. A “processor” as the term is generally used herein may therefore comprise portions or combinations of a microprocessor, ASIC, FPGA, CPU, ALU, DSP or other image processing circuitry.

The memory 122 stores software code for execution by the processor 120 in implementing portions of the functionality of image processor 102, such as the subsystems 108 and 116 and the GR applications 118. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the GR system 110 of image processor 102 will now be described in greater detail with reference to the diagrams of FIGS. 2 through 8.

It is assumed in these embodiments that the input images 111 received in the image processor 102 from an image source comprise respective depth images. As indicated above, this exemplary image source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices illustratively contain per-pixel information such as depth values and corresponding amplitude or intensity values. Other per-pixel information such as color, phase and validity may additionally or alternatively be provided.

In some embodiments, the image sensor is configured to operate at a variable frame rate, such that the static pose recognition module 114 or at least portions thereof can operate at a lower frame rate than other recognition modules 115, such as recognition modules configured to recognize cursor gestures and dynamic gestures. However, use of variable frame rates is not a requirement, and a wide variety of other types of image sources supporting fixed frame rates can be used in implementing a given embodiment.

Certain types of image sources suitable for use in embodiments of the invention are configured to provide both depth and amplitude images. It should therefore be understood that the term “depth image” as broadly utilized herein may in some embodiments encompass an associated amplitude image. Thus, a given depth image may comprise depth information as well as corresponding amplitude information. For example, the amplitude information may be in the form of a grayscale image or other type of intensity image that is generated by the same image sensor that generates the depth information. An amplitude image of this type may be considered part of the depth image itself, or may be implemented as a separate image that corresponds to or is otherwise associated with the depth image. Other types and arrangements of depth images comprising depth information and possibly having associated amplitude information may be generated in other embodiments.

Accordingly, references herein to a given depth image should be understood to encompass, for example, an image that comprises depth information only, or an image that comprises a combination of depth and amplitude information. The depth and amplitude images mentioned previously therefore need not comprise separate images, but could instead comprise respective depth and amplitude portions of a single image.

Referring now to FIG. 2, a process 200 performed by the static pose recognition module 114 in an illustrative embodiment is shown. The process is assumed to be applied to preprocessed image frames received from a preprocessing subsystem of the set of additional subsystems 116. The preprocessing subsystem performs noise reduction and background estimation and removal, using techniques such as those identified above. The image frames are received by the preprocessing system as raw image data from an image sensor of a depth imager such as an SL or ToF camera or other type of SL or ToF imager.

The process 200 as illustrated in FIG. 2 comprises steps 201 through 211. Steps 203, 204 and 207 are shown in dashed outline as such steps are considered optional in the present embodiment, although this notation should not be viewed as an indication that other steps are required in any particular embodiment. Each of the above-noted steps of the process 200 will be described in greater detail below. In other embodiments, certain steps may be combined with one another, or additional or alternative steps may be used.

In step 201, a hand region of interest (ROI) is detected in an input depth map. The input depth map corresponds to a particular image frame in a sequence of image frames to be processed. Detection of the hand ROI more particularly involves defining an ROI mask for a particular region in the depth map that corresponds to a hand of a user in an imaged scene. This region is also referred to as a “hand region.”

The output of the ROI detection step in the present embodiment therefore includes an ROI mask for the hand region in the input image. The ROI mask can be in the form of an image having the same size as the input image, or a sub-image containing only those pixels that are part of the ROI.

For further description of process 200, it is assumed that the ROI mask is implemented as a binary ROI mask that is in the form of an image, also referred to herein as a “hand image,” in which pixels within the ROI are have a certain binary value, illustratively a logic 1 value, and pixels outside the ROI have the complementary binary value, illustratively a logic 0 value. The binary ROI mask may therefore be represented with 1-valued or “white” pixels identifying those pixels within the ROI, and 0-valued or “black” pixels identifying those pixels outside of the ROI. As indicated above, the ROI corresponds to a hand within the input image, and is therefore also referred to herein as a hand ROI.

It is also assumed that the binary ROI mask generated in step 201 is an image having the same size as the input image. Thus, by way of example, assuming that a depth map d provided as input to step 201 in the present embodiment comprises a pixel matrix having dimension W×H, the binary ROI mask generated in step 201 will also comprise a pixel matrix having dimension W×H.

Depth values and possibly also amplitude values or other types of per-pixel information are associated with respective pixels of the ROI that is defined by the binary ROI mask. These ROI pixels are assumed to be part of or otherwise associated with the input depth map.

A variety of different techniques can be used to detect the ROI in step 201. For example, it is possible to use techniques such as those disclosed in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

As another example, the ROI can be defined using threshold logic applied to depth values associated with respective pixels of the depth map. In an arrangement of this type, the ROI can be detected at least in part by selecting for inclusion in the ROI only those pixels with depth values falling between predefined minimum and maximum threshold depths Dmin and Dmax. These thresholds are set to appropriate distances between which the hand region is expected to be located within the image. For example, the thresholds may be set as Dmin=0, Dmax=0.5 meters (m), although other values can be used.

In conjunction with detection of the ROI, opening or closing morphological operations utilizing erosion and dilation operators can be applied to remove dots and holes as well as other spatial noise in the image.

In embodiments in which the input image comprises amplitude information in addition to depth information, the ROI can be detected at least in part by selecting only those pixels with amplitude values greater than some predefined threshold. For active lighting imagers such as SL or ToF imagers or active lighting infrared imagers, the closer an object is to the imager, the higher the amplitude values of the corresponding image pixels, not taking into account reflecting materials. Accordingly, selecting only those pixels with relatively high amplitude values for the ROI allows one to preserve close objects from an imaged scene and to eliminate far objects from the imaged scene.

It should be noted that for SL or ToF imagers that provide both depth and amplitude information, pixels with lower amplitude values tend to have higher error in their corresponding depth values, and so removing pixels with low amplitude values from the ROI additionally protects one from using incorrect depth information.

One possible implementation of a threshold-based ROI determination technique using both depth and amplitude thresholds is as follows:

1. Set ROIij=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

The output of the above-described ROI determination process is a binary ROI mask for the hand in the image. As mentioned above, it is assumed to have the same size as the input image, and its pixels are associated with respective depth values and possibly amplitude values or other per-pixel information from the input image.

In step 202, a 2D contour of the hand ROI is determined. This determination of the contour of the hand ROI advantageously permits the contour to be used in place of the hand ROI in subsequent processing steps. By way of example, the contour is represented as ordered list of points characterizing the general shape of the hand ROI. The use of such a contour in place of the hand ROI itself provides substantially increased processing efficiency in terms of both computational and storage resources.

A given extracted 2D contour determined in step 202 of the process 200 can be expressed as an ordered list of n contour points. Each of the contour points includes both an x coordinate and a y coordinate, so the extracted 2D contour can be represented as a vector of 2D coordinates. More particularly, the output of step 202 in the present embodiment illustratively comprises a 2D contour in the form of a vector of 2D coordinates (x₁,y₁), (x₂,y₂), . . . (xₙ,yₙ), where n is the contour length and the contour points (xᵢ,yᵢ) are pairs of non-negative image pixel coordinates such that 0≦xᵢ≦W, 0≦yᵢ≦H.

The contour extraction may be implemented at least in part utilizing known techniques such as S. Suzuki and K. Abe, “Topological Structural Analysis of Digitized Binary Images by Border Following,” CVGIP 30 1, pp. 32-46 (1985), and C. H. Teh and R. T. Chin, “On the Detection of Dominant Points on Digital Curve,” PAMI 11 8, pp. 859-872 (1989).

The static pose recognition module 114 in some embodiments is configured to operate on either right hand versions or left hand versions. For example, in one possible arrangement of this type, if it is determined that a given extracted contour or its associated hand ROI is a left hand ROI when the module 114 is configured to process right hand ROIs, then the normalization involves horizontally flipping the points of the extracted contour, such that all of the extracted contours subject to further processing correspond to right hand ROIs. However, it is possible in other embodiments for the module 114 to process both left hand and right hand versions, such that no normalization to a particular left or right hand configuration is needed.

Further details regarding exemplary contour extraction techniques and left hand and right hand normalizations can be found in Russian Patent Application Attorney Docket No. L13-1279RU1, filed Jan. 22, 2014 and entitled “Image Processor Comprising Gesture Recognition System with Static Hand Pose Recognition Based on Dynamic Warping,” which is commonly assigned herewith and incorporated by reference herein.

Additionally or alternatively, information such as a main direction of the hand can be determined and utilized to facilitate distinguishing left hand and right hand versions of the extracted contours. Exemplary techniques for determining hand main direction are disclosed in Russian Patent Application No. 2013148582, filed Oct. 30, 2013 and entitled “Image Processor Comprising Gesture Recognition System with Computationally-Efficient Static Hand Pose Recognition,” which is commonly assigned herewith and incorporated by reference herein. This particular patent application further discloses additional relevant techniques, such as skeletonization operations for determining a hand skeleton in a hand image. Such techniques may be applied in conjunction with distinguishing left hand and right hand versions of an extracted contour in a given embodiment. For example, a skeletonization operation may be performed on a hand ROI, and a main direction of the hand ROI determined utilizing a result of the skeletonization operation.

Other information that may be taken into account in distinguishing left hand and right hand versions of an extracted contour includes, for example, a mean x coordinate of points of intersection of the hand ROI and a bottom row or other designated row of the frame, with the mean x coordinate being determined prior to removing from the hand ROI any pixels below a palm boundary as described elsewhere herein.

In step 203, the input depth map d is denoised and extended to produce a refined depth map for the ROI and possibly adjacent pixels. As indicated above, for ToF imagers, depth map precision is inversely proportional to input image amplitude. Accordingly, as the brightest pixels generally correspond to points on an imaged object that are perpendicular to the direction to the image sensor, hand ROI edges and therefore the extracted contour can be noisy. Also, for SL imagers, object borders are typically corrupted so that depth information may not be known accurately for pixels close to the ROI contour. These and other related issued are addressed in step 203 by reconstructing or otherwise refining the depth information corresponding to the ROI contour pixels. Also, this step extends the depth information from within ROI region by one or more pixels outward from edge pixels of the ROI.

Such operations can be implemented at least in part utilizing techniques disclosed in the above-cited PCT International Application PCT/US13/56937, as well as PCT International Application PCT/US13/41507, filed on May 17, 2013 and entitled “Image Processing Method and Apparatus for Elimination of Depth Artifacts,” and Russian Patent Application Attorney Docket No. L13-1280, filed Feb. 7, 2014 and entitled “Depth Image Generation Utilizing Depth Information Reconstructed from an Amplitude Image,” all of which are commonly assigned herewith and incorporated by reference herein.

By way of example, depth information reconstruction for pixels with unknown or otherwise unreliable depth may be implemented using the following process:

1. Exclude from the depth map pixels with low amplitude values or pixels associated with high depth or amplitude gradients, and replace them with predetermined values, such as zero depth values.

2. Apply an image dilation morphological operation to the hand ROI using a specified dilation factor Ext≧>1 to obtain an extended mask ROIext.

3. For each pixel (i,j) from ROIext, if depth d(i,j) is unknown or otherwise unreliable but there exists a neighbor (i1,j1) of this pixel with a known depth value d(i1,j1), set d reconstructed(i,j)=d(i1,j1). If the specified neighborhood of pixel (i,j) contains more than one pixel with a known depth value, an average of the values may be used as the reconstructed depth value, or any one of the alternative depth values may be selected and used as the reconstructed depth value.

4. For all reconstructed pixels (i,j), set d(i,j)=d_reconstructed(i,j).

5. Repeat steps 3 and 4 above until all pixels from ROIext have known depth.

The output of this process is the above-noted refined depth map with depth reconstruction limited to pixels of the ROI and pixels adjacent to pixels of the ROI, where “limited to” in this context denotes that refinements are made for pixels in the ROI and possibly also for pixels within a designated neighborhood of or otherwise adjacent to pixels of the ROI.

In step 204, the 2D contour obtained in step 202 is simplified and smoothed. For example, this step may apply algorithms such as the Ramer-Douglas-Peucker (RDP) algorithm to reduce the number of points in the extracted contour. In applying the RDP algorithm to the contour, the degree of coarsening may be altered as a function of distance to the hand. This involves, for example, altering an 8-threshold in the RDP algorithm based on an estimate of mean distance to the hand over the pixels of the hand ROI.

The particular number of points included in the simplified contour can vary for different types of hand ROI masks. Contour simplification not only conserves computational and storage resources as indicated above, but can also provide enhanced recognition performance. Accordingly, in some embodiments, the number of points in the contour is kept as low as possible while maintaining a shape close to the actual hand ROI.

The smoothing applied to the 2D contour in step 204 illustratively involves adjusting the number and spacing of the contour points in order to improve the regularity of the point distribution over the contour. Such adjustment is useful in that different types of contour extraction can produce different and potentially irregular point distributions, which can adversely impact recognition quality. This is particularly true for embodiments in which the contour is simplified after or in conjunction with extraction, as in step 204 in the present embodiment. In some embodiments, it has been found that recognition quality generally increases with increasing regularity in the distribution of the contour points.

An exemplary technique for improving the regularity of the point distribution over the contour involves converting an initial extracted contour comprising an ordered list of points c₁, . . . , cₙ into a processed list of points cc₁, . . . , ccₘ, where distances ∥ccᵢ−ccᵢ₊₁∥ are approximately equal for all i=1 . . . m−1, and where m may, but need not, be equal to n. Numerous other smoothing techniques may be used.

Additional details regarding contour simplification and smoothing techniques suitable for use in embodiments of the present invention can be found in the above-cited Russian Patent Application Attorney Docket No. L13-1279RU1.

In step 205, the 2D contour is converted to a 3D contour. This step receives as its inputs the refined depth map from step 203 and the refined 2D contour from step 204. The 2D contour is converted to a 3D contour in the present embodiment by converting 2D contour points (i,j,d(i,j)) to respective 3D contour points in Cartesian coordinates (x,y,z), where (i,j) denotes a 2D contour pixel coordinate and d(i,j) is the depth value at that pixel. This may be done using a known transform between optical and Cartesian coordinate systems for a given image sensor. For example, in the case of a typical image sensor, the following transform may be used to perform the conversion for a given 2D contour point:

dx=2*tan(α/2)/W*(i−(W−1)/2)

dy=2*tan(β/2)/H*(j−(H−1)/2)

z=d(i,j)/sqrt(1+dx²+dy²)

x=z*dx

y=z*dy

In this example, α and β denote respective horizontal and vertical viewing ranges of the image sensor. It should be noted that the above equations do not take into account possible optical distortion attributable to the image sensor lens, although in other embodiments such optical distortion can be taken into account, for example, utilizing techniques such as those disclosed in Duane C. Brown, “Decentering distortion of lenses,” Photogrammetric Engineering, 32 (3): 444-462, May 1966.

It should be noted that the above-described conversion is applied only to the limited set of points of the simplified contour. By way of example, this set may comprise on the order of 30 contour points representing a single hand, although other numbers of contour points may be used. The particular number of contour points used in a given embodiment is generally not a function of the resolution of the image sensor.

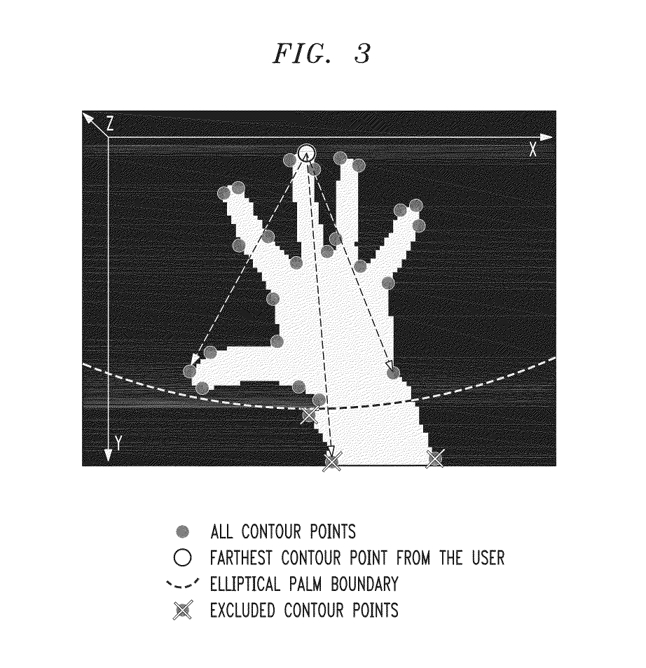

The output of step 206 in the present embodiment may comprise a 3D contour that includes not only the hand itself but also some portion of the arm adjacent the hand. This is illustrated in FIG. 3, which shows an exemplary hand image illustrating contour points as well as a boundary between the hand and the adjacent portion of the arm. This boundary is shown as a dashed line in FIG. 3 and is referred to herein as a “palm boundary” or “wrist boundary.”

In step 206, the portion of the 3D contour below the palm boundary is “cut off” or otherwise removed from the contour. Such an operation advantageously eliminates, for example, any portions of the arm from the wrist to the elbow, as these portions can be highly variable due to the presence of items such as sleeves, wristwatches and bracelets, and in any event are typically not useful for hand gesture recognition.

Contour points that are excluded as a result of this operation in the FIG. 3 example are denoted by X marks.

By way of example, the determination of the palm boundary and exclusion of contour points below the palm boundary in the present embodiment can be determined using the following process:

1. Find the contour point that is farthest from the user. For example, if the y axis is directed towards the user, the contour point that is farthest from the user can be identified as the contour point having the minimum y coordinate value among all of the contour points. The identified contour point is denoted as having an index itip. This point is illustrated as a circled contour point in the FIG. 3 example.

2. Exclude from the contour all contour points with index i that have distance d_tip(i)≧sqrt((x(i)−x(itip))²+((y(i)−y(itip))*Y_{weight})²(z(i)−z(itip))²)Y^{weight}. Here Y_{weight} is a positive constant, Y_{weight}≧1 (e.g., Y_{weight}=1.5) which is used to establish a higher weighting for y coordinates than x and z coordinates.

The above process effectively removes all contour points below an elliptical palm boundary, as illustrated in FIG. 3. The process can be configured to prevent removal of contour points in certain situations, such as ones in which the thumb is opened sufficiently wide to allow portions of it to fall below the palm boundary.

Other techniques suitable for use in determining a palm boundary are described in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

Alternative techniques can be used. For example, the palm boundary may be determined by taking into account that the typical length of the human hand is about 20-25 centimeters (cm), and removing from the contour all points located farther than a 25 cm threshold distance from the uppermost fingertip, possibly along a determined main direction of the hand.

In other embodiments, palm boundary detection and associated removal below the boundary can be applied at other points in the process 200, such as when determining the binary ROI mask in step 201. In arrangements of this type, the uppermost fingertip can be identified simply as the uppermost 1 value in the binary ROI mask.

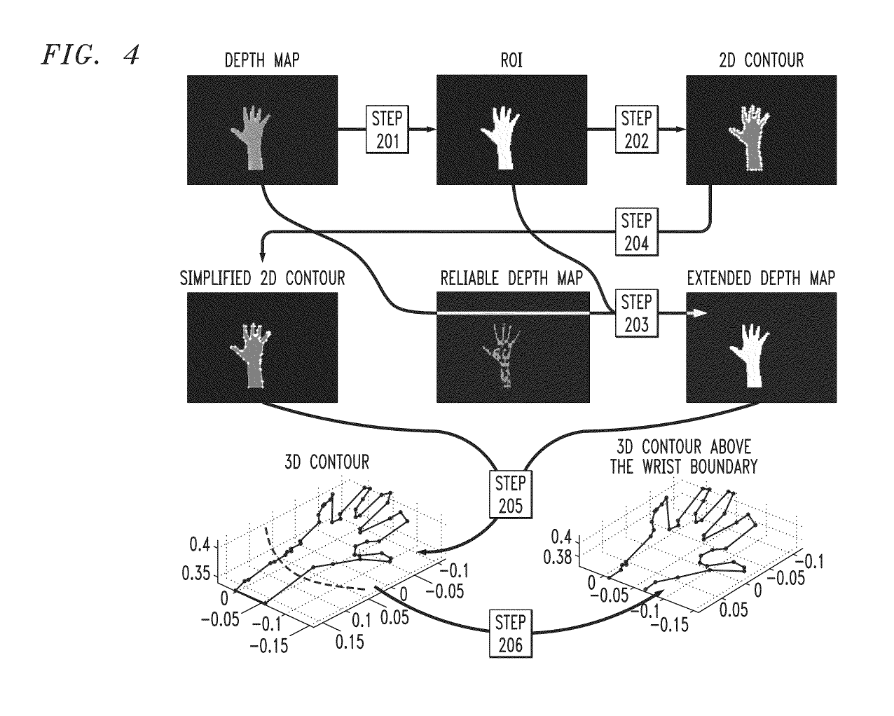

Application of the above-described steps 201 through 206 of process 200 to an exemplary hand image is illustrated in FIG. 4. In this example, the refined depth map generated in step 203 is also referred to as an “extended depth map” and is based on both the hand ROI and a denoised depth map also referred to as a “reliable depth map.” The 3D contour generated by step 205 is cut off below an elliptical palm boundary denoted by a dashed line to produce the 3D contour including only contour points above the boundary as illustrated.

In step 207, the 3D contour of the hand is “regularized” by adding new contour points. Such a regularizing operation alters the 3D contour point distribution to make it more homogenous, and can help to overcome possible inaccuracies introduced by previous contour simplification operations.

By way of example, the contour regularizing can be performed using the following process:

1. Define the maximal contour edge length Dmax (e.g., Dmax=0.02 m)

2. For each edge (i,i+1) of the contour, estimate its length d(i) in a Cartesian coordinate system.

3. If for some edge (i,i+1) d(i)>Dmax, split the edge into [d(i)/Dmax]+1 equal parts and add the new points to the contour in the corresponding order, where [.] denotes the integer part of a real number.

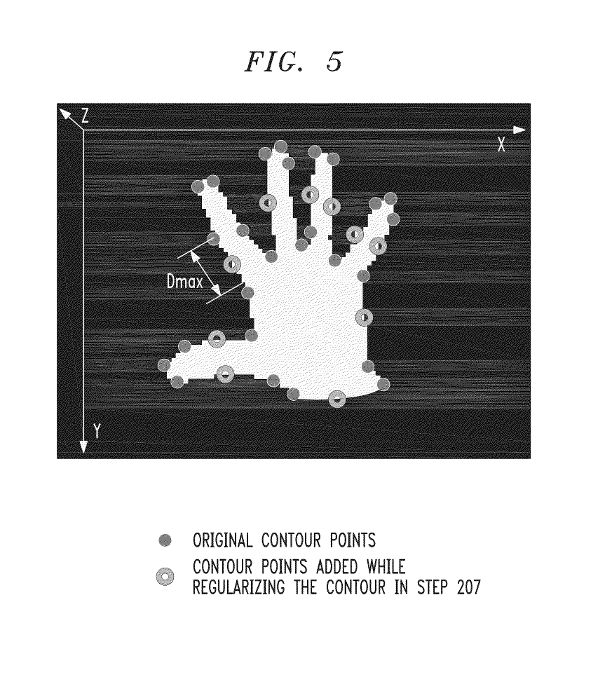

The addition of multiple new contour points to the 3D contour of the FIG. 3 example using the regularizing operation of step 207 is shown in FIG. 5. It is apparent that the new contour points are added after removal of contour points below the palm boundary in step 206.

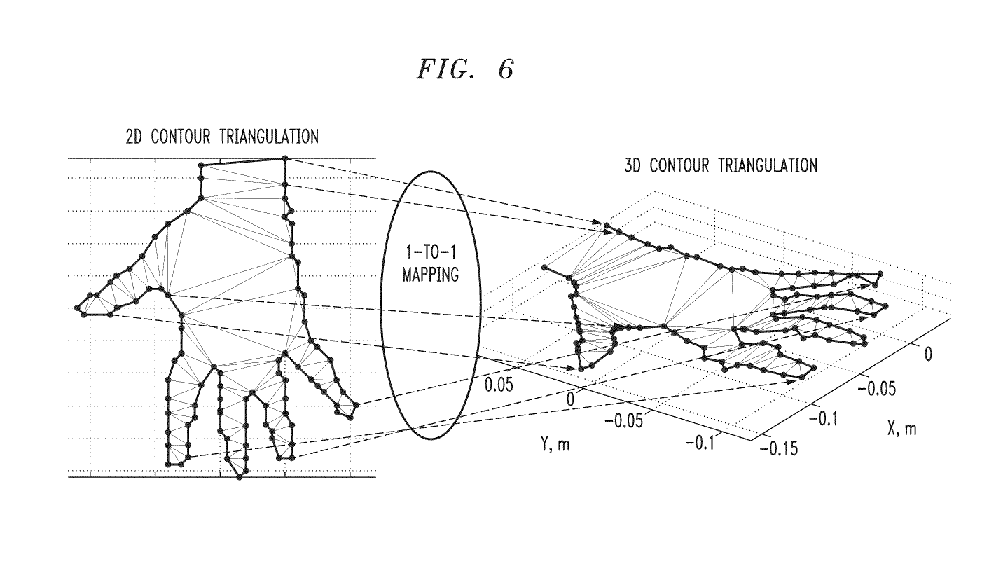

In step 208, an area bounded by the 3D contour of the hand is triangulated. The resulting triangulation includes only points that are part of the contour and no points within the area bounded by the contour. The triangulation may be done directly in 3D space. Alternatively, a 2D contour prototype may first be triangulated and then mapped to a 3D contour triangulation using a 1-to-1 mapping between 2D and 3D contour points, as illustrated in FIG. 6. The triangulation process may make use of known triangulation techniques, such as polygon triangulation or Delauney triangulation.

Step 208 is an example of what is more generally referred to herein as “triangulating” a determined contour, and such triangulating in the present embodiment involves covering all or substantially all of a surface or other area bounded by the determined contour using triangles with vertices that correspond to respective contour points. The resulting contour is referred to herein as a “triangulated contour.” Other types of triangulation can be used in other embodiments, and terms such as “triangulating” are therefore intended to be broadly construed. Also, in some embodiments, other types of polygons can be used instead of or in combination with triangles, and the term “triangulating” is intended to encompass arrangements of the latter type that utilize triangles as well as one or more other types of polygons. A “triangulated” contour in some embodiments may therefore include not only triangles but also other types of polygons, as the term is broadly used herein.

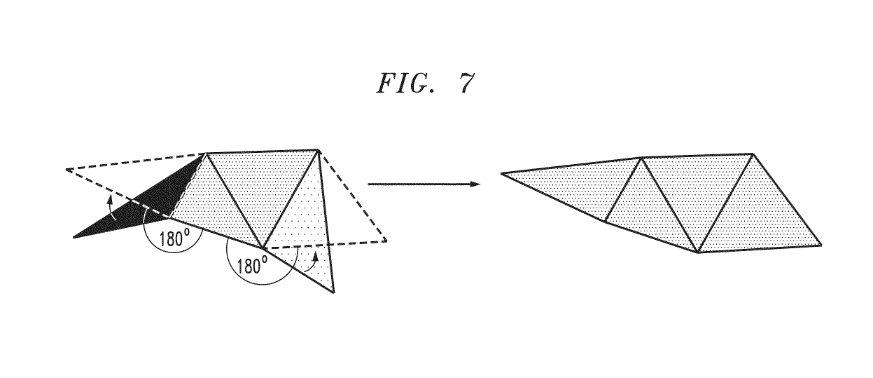

In step 209, the triangulation is flattened. As all of the points of the triangulation are located on the contour, the triangulated contour can be flattened by replacing an existing angle between a given pair of adjacent triangles with an angle of 180 degrees. This replacement is repeated for all other pairs of adjacent triangles, where adjacent triangles are identified as triangles sharing a common side. The flattening process is illustrated in FIG. 7 for two different pairs of adjacent triangles. In other embodiments, angles of approximately 180 degrees or other values above or below 180 degrees could be used.

The flattening can be performed by recalculating the coordinates of each contour point. In this case, only two coordinates are used as the flattened contour is located in a plane and so the third coordinate can be ignored. Alternatively, the flattening can be performed virtually by taking into account that the flattened contour is now once again a 2D contour and keeping lengths of the contour sides d(i) and inter-contour distances (i.e., inner sides of the triangulation triangles) the same as in the 3D contour.

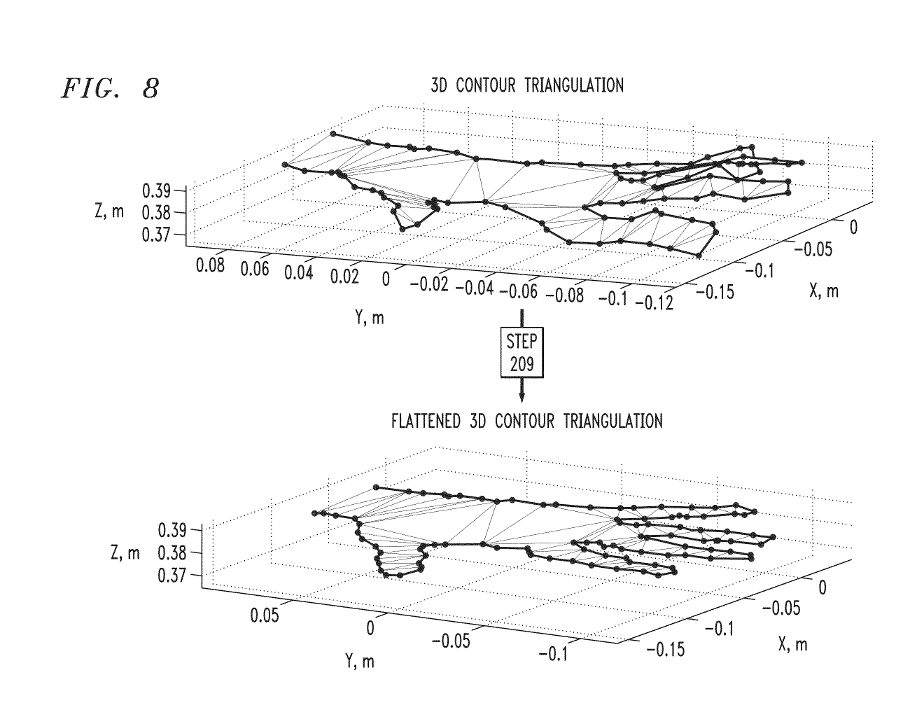

An exemplary 3D contour triangulation and its corresponding flattened 3D contour triangulation are illustrated in FIG. 8. The contour flattening maintains features such as hand contour perimeter, hand surface area, and local distances corresponding to triangulation edges between contour points. Also, global characteristics such as width, height and central moments are improved and made closer to the actual characteristics of a hand.

Step 209 is an example of what is more generally referred to herein as “flattening” a triangulated contour, and such flattening in the present embodiment involves altering one or more angles between respective pairs of triangles in the triangulated contour. The resulting contour is referred to herein as a “flattened contour.”

In step 210, features of the flattened contour are estimated as needed to perform hand pose classification. Various sets of features may be used. Some examples include the following features:

1. Hand perimeter, given by a sum of contour edges: P=sum(d(i), i=1 . . . n). The d(i) values were previously determined in step 207 and therefore do not need to be recalculated.

2. Hand surface area, given by a sum of areas of triangulation triangles: A=sum(a(i), i=1 . . . m). The area a(i) of each triangle may be estimated using techniques such as Heron's formula. Again, the d(i) values previously determined in step 207 can be reused here. Also, internal edge lengths d(i,j) for contour points i and j connected by triangulation edges are calculated only once per edge.

3. First and second order moments, calculated based on a set of weighted points where points correspond to geometric centers of triangles (i.e., mean x and y coordinates of the three vertices of a given triangle) and the weights are respective triangle areas. For example, one such moment can be computed as Mxx=sum(mx(i)²*a(i))/A where mx(i) is an x coordinate of the geometric center of the i-th triangle.

4. Hand width and height, given by max(x(i),i=1 . . . n)-min(x(i),i=1 . . . n) and max(y(i),i=1 . . . n)-min(y(i),i=1 . . . n) where (x(i),y(i)) denotes the coordinates of an i-th flattened contour point.

Additional examples of features suitable for use in embodiments of the present invention can be found in the above-cited Russian Patent Application No. 2013148582 and Russian Patent Application Attorney Docket No. L13-1279RU1.

It should be noted that the above-described hand features are exemplary only, and additional or alternative hand features may be utilized to facilitate static pose recognition in other embodiments. For example, various functions of one or more of the above-described hand features or other related hand features may be used as additional or alternative hand features. Also, techniques other than those described above may be used to compute the features.

The particular number of features utilized in a given embodiment will typically depend on factors such as the number of different hand pose classes to be recognized, the shape of an average hand inside each class, and the recognition quality requirements. Techniques such as Monte-Carlo simulations or genetic search algorithms can be utilized to determine an optimal subset of the features for given levels of computational complexity and recognition quality.

In step 211, the estimated features are utilized to classify the hand pose in the current input depth map. This classification involves use of training pose patterns 212 for respective static pose classes to be recognized. More particularly, classifiers for respective ones of the static pose classes are trained in advance using corresponding patterns of known hand poses taken from one or more training databases.

Each static pose class utilizes a corresponding classifier configured in accordance with a classification technique such as, for example, Gaussian Mixture Models (GMMs), Nearest Neighbor, Decision Trees, and Neural Networks. Additional details regarding the use of classifiers based on GMMs in the recognition of static hand poses can be found in the above-cited Russian Patent Application No. 2013134325.

The particular types and arrangements of processing operations shown in the embodiment of FIG. 2 are exemplary only, and additional or alternative operations can be used in other embodiments. For example, steps illustratively shown as being executed serially in the figures can be performed at least in part in parallel with one or more other steps or in other pipelined configurations in other embodiments.

The illustrative embodiments provide significantly improved gesture recognition performance relative to conventional arrangements. For example, these embodiments provide significant enhancement in the computational efficiency of static pose recognition through the use of contour triangulation and flattening. Accordingly, the GR system performance is accelerated while ensuring high precision in the recognition process. The disclosed techniques can be applied to a wide range of different GR systems, using depth, grayscale, color infrared and other types of imagers which support a variable frame rate, as well as imagers which do not support a variable frame rate.

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising steps of:
identifying a hand region of interest in at least one image;
determining a contour of the hand region of interest;
triangulating the determined contour;
flattening the triangulated contour;
computing one or more features of the flattened contour; and
recognizing a static pose of the hand region of interest based at least in part on the one or more computed features;
wherein the steps are implemented in an image processor comprising a processor coupled to a memory.

2. The method of claim 1 wherein the steps are implemented in a static pose recognition module of a gesture recognition system of the image processor.

3. The method of claim 1 wherein identifying a hand region of interest comprises generating a hand image comprising a binary region of interest mask in which pixels within the hand region of interest all have a first binary value and pixels outside the hand region of interest all have a second binary value complementary to the first binary value.

4. The method of claim 1 wherein the determined contour comprises an ordered list of points.

5. The method of claim 1 wherein triangulating the determined contour comprises covering substantially all of an area bounded by the determined contour using triangles with vertices that correspond to respective contour points.

6. The method of claim 5 wherein all of the vertices of the triangles used in the triangulating step correspond to contour points such that none of the triangles includes a vertex inside the bounded area.

7. The method of claim 1 wherein flattening the triangulated contour comprises altering one or more angles between respective pairs of triangles in the triangulated contour.

8. The method of claim 7 wherein altering one or more angles between respective pairs of triangles comprises replacing each of a plurality of such angles with an angle of approximately 180 degrees.

9. The method of claim 1 wherein determining a contour of the hand region of interest comprises:
determining a two-dimensional contour of the hand region of interest; and
converting the two-dimensional contour to a three-dimensional contour;
wherein the triangulating step is applied to the three-dimensional contour.

10. The method of claim 9 further comprising applying at least one of a simplification operation and a smoothing operation to the two-dimensional contour prior to converting the two-dimensional contour to a three-dimensional contour.

11. The method of claim 9 further comprising:
identifying a palm boundary of the three-dimensional contour.

12. The method of claim 11 further comprising:
modifying the three-dimensional contour to exclude contour points outside the identified palm boundary.

13. The method of claim 9 further comprising regularizing the three-dimensional contour by altering at least one of number and distribution of its contour points prior to applying the triangulating step to the three-dimensional contour.

14. The method of claim 9 wherein converting the two-dimensional contour to a three-dimensional contour utilizes a refined depth map comprising one or more reconstructed depth values generated for respective pixels.

15. The method of claim 14 wherein a given one of the reconstructed depth values is generated at least in part based on one or more pixels of an input depth map that are not part of the hand region of interest but are instead within a specified neighborhood of at least one pixel that is part of the hand region of interest.

16. An apparatus comprising:
an image processor comprising image processing circuitry and an associated memory;
wherein the image processor is configured to implement a gesture recognition system utilizing the image processing circuitry and the memory, the gesture recognition system comprising a static pose recognition module; and
wherein the static pose recognition module is configured to identify a hand region of interest in at least one image, to determine a contour of the hand region of interest, to triangulate the determined contour, to flatten the triangulated contour, to compute one or more features of the flattened contour, and to recognize a static pose of the hand region of interest based at least in part on the one or more computed features.

17. The apparatus of claim 16 wherein the determined contour comprises an ordered list of points.

18. The apparatus of claim 16 wherein the triangulated contour comprises covering substantially all of an area bounded by the determined contour using triangles with vertices that correspond to respective contour points.

19. The apparatus of claim 18, wherein all of the vertices of the triangles used in the triangulated contour correspond to contour points such that none of the triangles includes a vertex inside the bounded area.

20. The apparatus of claim 16 wherein the static pose recognition module determines the contour of the hand region of interest by determining a two-dimensional contour of the hand region of interest and converting the two-dimensional contour to a three-dimensional contour, and wherein the three-dimensional contour is triangulated to provide the triangulated contour.
